(19) United States
(12) Patent Application Publication
(10) Pub. No.: US 2011/0297653 A1
(43) Pub. Date: Dec. 8, 2011

(54) METHOD AND DEVICE FOR PRODUCING NANO-STRUCTURED SURFACES

(75) Inventors: LUTZ EHRENTRAUT, ZEUTHEN (DE); ARKADI ROSENFELD, BERLIN (DE); INGOLF HERTEL, BERLIN (DE)

(73) Assignee: FORSCHUNGSVERBUND BERLIN E.V., BERLIN (DE)

(21) Appl. No.: 13/155,495

(22) Filed: Jun. 8, 2011

(30) Foreign Application Priority Data
Jun. 8, 2010 (DE) 10 2010 023 568.7

(51) Int. Cl. B23K 26/34

(52) U.S. Cl. 219/121.61; 219/121.85

(57) ABSTRACT

An apparatus and a method for producing nanostructured surfaces are particularly suited for producing surfaces having very low roughness over large lateral extents. The method includes the following steps: providing an article having a surface to be structured; generating short-pulse laser radiation with laser pulses whose pulse durations lie in the subnanosecond range, preferably in the range of 100 fs to 300 fs, directing the short-pulse laser radiation onto the surface to be structured on the article, such that a fluence F of each individual pulse of the short-pulse laser radiation is less than a multishot threshold fluence Fₜₕ for a multishot laser ablation, but the fluence F is chosen to be high enough that defects can be produced by way of nonlinear interactions. Preferably, a fluence F in the range of 65% to 95% of the multishot threshold fluence Fₜₕ for a multishot laser ablation is used.

The invention relates to an apparatus and a method for producing nanostructured surfaces, in particular for producing surfaces having a very low roughness over large lateral extents.

In the field of the semiconductor industry and astronomy there is a need to be able to produce surfaces having very high surface qualities, in particular a very low roughness. Mechanical methods make it possible to polish surfaces in such a way that the latter locally have an rms roughness (root mean square deviation) of the order of magnitude of 0.5 to 1 nm. Over laterally extended areas having dimensions in the range of a few centimeters or decimeters, however, height fluctuations in such mechanically highly precisely polished areas of the order of magnitude of a few 10 nm to 100 nm occur, that is to say generally height differences in the range of up to approximately 100 nm. In order to be able to produce laterally extended planar surfaces having a roughness, in the prior art the surface is measured optically by an interferometric method in order to determine the height fluctuations over the large extended lateral area. Afterward, the article having the surface to be structured is introduced into a vacuum and the surface is processed by means of corpuscular radiation, in particular electron radiation, in order to remove regions having a large height.

The measurement of the lateral height differences and structuring in a vacuum have to be iteratively performed multiply, if appropriate, in order to obtain a laterally extended area having a roughness or root-mean-square roughness in the range of 1 nm. Structuring under vacuum conditions is very complex and very time-intensive.

Consequently, the invention addresses the technical problem of providing an improved method and an improved apparatus for producing surfaces having low roughness, in particular for producing laterally extended surfaces having low roughness.

### BASIC CONCEPT OF THE INVENTION

The invention is based on the concept of structuring the surface by incidence of short-pulse laser light under normal pressure conditions, without performing ablation of material. For this purpose, by means of nonlinear effects, defects are produced in the article to be structured, which leads to a compression of the article. By means of targeted/controlled local production of defects, it is possible to achieve a local compression of the article and hence a structuring of the surface of the article in order to alter the height structure of the surface of said article.

### Preferred Embodiments

In particular, a method for producing nanostructured surfaces, in particular for producing laterally extended surfaces having low roughness, is proposed, which comprises the following steps: providing or producing an article having a surface to be structured; generating short-pulse laser radiation comprising laser pulses whose pulse durations lie in the subnanosecond range, and are preferably shorter than 10 ps, and most advantageously have pulse durations in the region of 0.2 ps; directing the short-pulse laser radiation onto the surface to be structured on the article, such that a fluence of each individual pulse of the short-pulse laser radiation at the surface of the object to be processed is less than a multishot threshold fluence Fₜₕ for a multishot laser ablation. The laser pulses are therefore generated in such a way that ablation does not take place anywhere over the entire cross-sectional area of the short-pulse laser radiation. Consequently, ablation occurs nowhere on the surface. Furthermore, the fluence is chosen such that no Coulomb explosion arises. Consequently, the energy is chosen to be always below a threshold starting from which a Coulomb explosion can arise. The short-pulse laser radiation has to be chosen such that defects can be produced in the article by means of nonlinear processes. Consequently, an apparatus for implementing this method comprises a short-pulse laser for generating short-pulse laser radiation comprising laser pulses whose pulse durations lie in the subnanosecond range, and are preferably shorter than 10 ps, and most expediently have pulse durations in the region of 0.2 ps, a beam guiding device for guiding the short-pulse laser radiation onto an article, and also a mount for accommodating the article whose surface is intended to be structured, wherein the short-pulse laser and the beam guiding device are embodied in such a way that a fluence of each individual pulse of the short-pulse laser radiation at the surface of the object to be processed is less than a multishot threshold fluence Fₜₕ for a multishot laser ablation. In this case, the beam guiding device also comprises such elements which perform beam shaping and, by this means, influence a radiation density on the surface or in the article whose surface is to be structured.

A major advantage of the method and of the apparatus is that the structuring can be performed under normal atmospheric conditions. Consequently, the method can be performed more rapidly and thereby more cost-effectively.

In one preferred embodiment, the fluence is chosen such that it is or has been chosen in the range of 50% to 99% of the multishot threshold fluence Fₜₕ, more preferably in the range of 65% to 95% of the multishot threshold fluence Fₜₕ. The multishot threshold fluence indicates that fluence for which ablation occurs in the case of multiple bombardment of the surface of the article. If the fluence is chosen to be less than the multishot threshold fluence Fₜₕ, ablation does not occur even when an arbitrary number of laser pulses impinge on the same location of the surface of the article. Furthermore, no Coulomb explosion occurs. The fluence is thus chosen such that no Coulomb explosion occurs. If, in the beam guiding device, a lens is used for focusing, then it may be necessary, in the case of a lens having a short focal length, to place the focus into the interior of the article in order to avoid plasma formation upstream of the surface to be structured in the atmosphere. If a lens having a long focal length is used, then it is generally possible for the focus also to be positioned onto the surface of the article. Alongside beam shaping, such as focusing, the fluence can be chosen and controlled by means of a suitable choice of laser parameters. In particular by controlling the power of the short-pulse laser and/or a gain of the short-pulse laser radiation.

It has proved to be particularly advantageous to generate the short-pulse laser radiation with a wavelength in the infrared wavelength range. Short-pulse lasers in the infrared wavelength range are commercially available. In particular, short-pulse lasers which generate laser pulses having pulse durations in the range of 100 to 300 fs are suitable. Consequently, by way of example, commercial titanium-sapphire laser systems (Ti: sapphire laser systems) which are equipped with an amplifier and which operate in the wavelength range of 800 nm are suitable.

Although imaging methods can also be utilized, in principle, the required pulse energy is lower in the case of a scanning method. In one embodiment, therefore, the structuring is performed by means of a laterally scanning method. For this purpose, it is provided that a scanning device is coupled to the beam guiding device and/or the mount, by means of which scanning device an impingement position of the short-pulse laser radiation on the surface of the article can be varied in a controlled manner, such that the surface can be scanned by the short-pulse laser radiation in a controlled manner. The article and the short-pulse laser radiation are thus moved relative to one another, such that an impingement point of the short-pulse laser radiation scans a region to be structured on the surface. The scanning device can either move the short-pulse laser radiation relative to a stationary surface of the article or move the article relative to the stationary laser radiation. Embodiments in which a combination of these two possibilities is realized are also conceivable. If the short-pulse laser radiation is varied with regard to its position spatially, then the scanning device can be integrated into the beam guiding device, for example can comprise drivable optical beam guiding devices, such as mirrors, gratings, etc.

Preferably, at least regions of the surface to be structured are scanned in a meandering fashion along parallel lines. It has proved to be particularly advantageous to adapt a beam profile of the short-pulse laser radiation to the scanning movement. If scanning is performed in a meandering fashion along parallel lines, then it is particularly advantageous if the beam profile is configured as far as possible homogeneously, for example in rectangular fashion, in cylindrical fashion (in a top-hat-like fashion). For this purpose, it is possible to use refractive or diffractive beam shaping elements comprising, for example, diffractive optical elements (DOE) or refractive elements.

In one preferred embodiment, the local structuring depth is controlled in a manner dependent on an effective pulse number N wherein the effective pulse number is given by:

$$N = \frac{R}{Δ z \cdot v} \cdot {A}_{short \text{-} pulsebeam} ,$$

wherein R is a repetition rate of the individual pulses in the short-pulse laser radiation, Δz indicates a distance between adjacent lines, v indicates a velocity of the relative movement of the short-pulse laser radiation along the line relative to the surface, and A_{short-pulse beam} indicates an area of the short-pulse laser radiation in the waist. This means that the structuring depth d, which indicates a measure of the compression, is dependent on the locally introduced pulse number of short laser pulses.

In one preferred embodiment, the structuring depth d, i.e. the change in the height of the surface, is controlled in accordance with the following formula: d=k·N^{c}, wherein N is the effective pulse member, k is a proportionality constant dependent on the material of the article, and c is a constant having a value in the range of between 0.45 and 0.55. Depending on the local height determined, the structuring depth can thus be chosen in a targeted manner such that it is changed in an adaptive manner, in order to compensate for the height fluctuations determined and thus to produce a laterally extended planar article, i.e. a surface having a desired roughness below a tolerance threshold. For this purpose, the surface to be structured has preferably been measured interferometrically or is measured interferometrically in order to detect and/or indicate height fluctuations of the surface along the large lateral extent.

The structuring depth d is controlled in a manner adapted to the height fluctuation, in order to produce the roughness of the surface of the order of magnitude of the local planarity prior to structuring of a larger lateral extent. The surface of the article is preferably polished mechanically prior to structuring and in this case attains a local roughness of the order of magnitude of 1 nm or less.

In one embodiment, the determination of the height fluctuations by means of an interferometric measurement and the structuring by means of the incidence of short-pulse laser radiation are iteratively performed alternately until a desired roughness has been achieved over a lateral extent of the surface. It is advantageous that no evacuation of the surroundings of the surface is necessary between the interferometric measurement and the structuring. With suitable configuration of the apparatus, the article with mount is moved to an interferometric measurement station arranged adjacent. Other embodiments provide for the interferometric measurement to be performed substantially simultaneously or simultaneously with the structuring. In this case, substantially simultaneously is intended to mean that the interferometric height determination for the surface is performed during the structuring, but at a different location, which is at a distance from the impingement point of the short-pulse laser radiation used for structuring.

The method can thus be used for producing extended surfaces having low roughness.

The invention is explained in greater detail below on the basis of a preferred exemplary embodiment with reference to a drawing, in which:

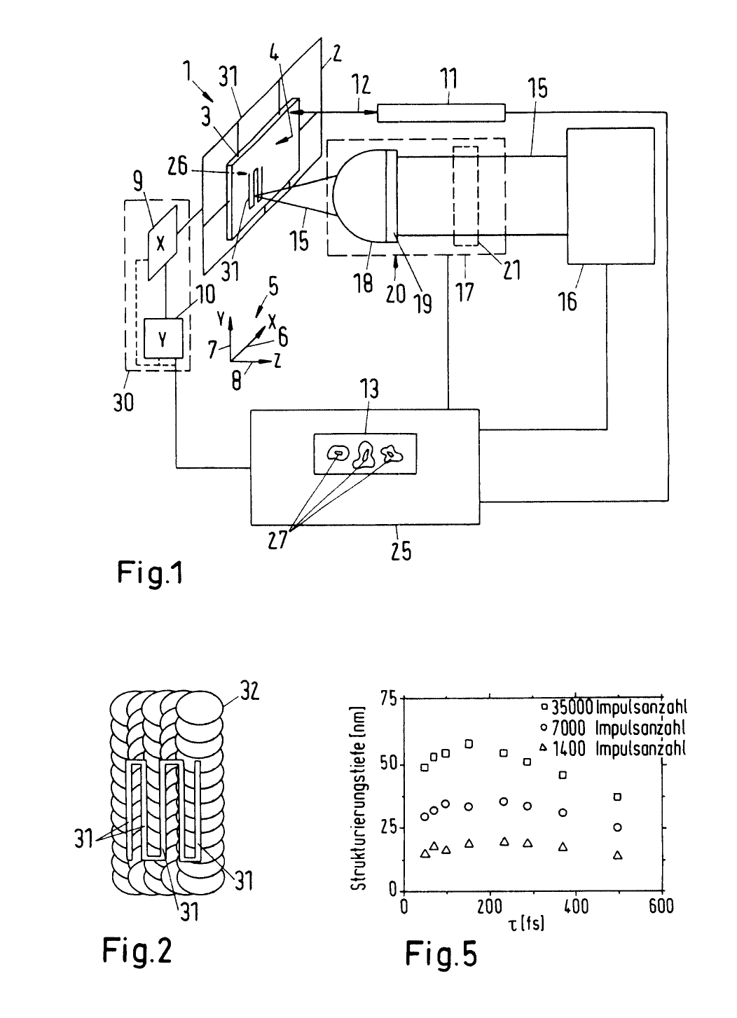

FIG. 1 shows a schematic illustration of an apparatus for the nanostructuring of surfaces;

FIG. 2 shows a schematic illustration for elucidating the scanning of a surface;

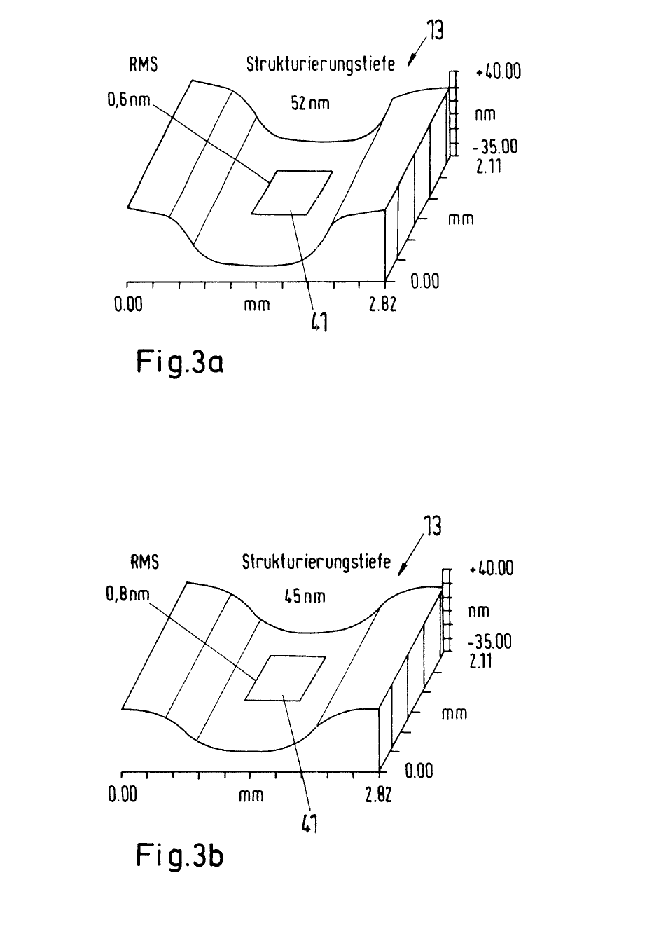

FIG. 3a, 3b show schematic illustrations for elucidating surface structuring on a Zerodur surface (3a) and a ULE glass (3b);

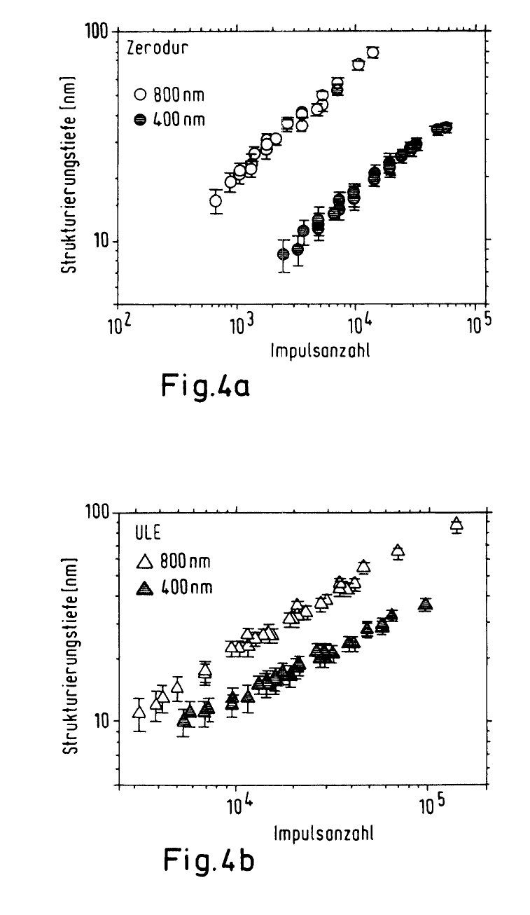

FIG. 4a, 4b show schematic illustrations showing a structuring depth as a function of a pulse number for Zerodur (4a) and ULE glass (4b) for different laser wavelengths;

FIG. 5 shows a schematic illustration of the structuring depth, plotted against a pulse duration for different total pulse numbers; and

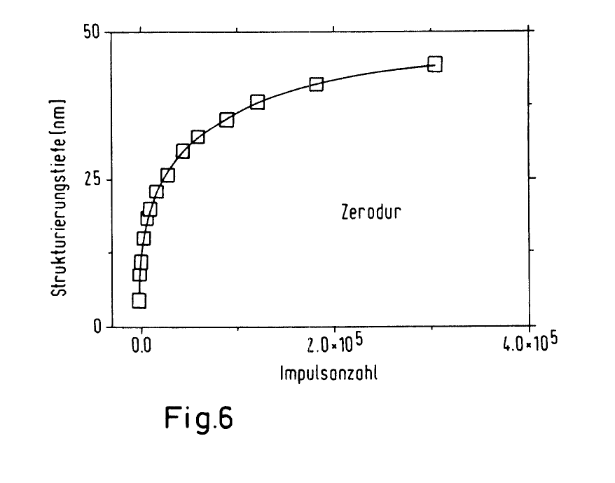

FIG. 6 shows a graphical illustration for elucidating a maximum achievable structuring depth as a function of the pulse number.

FIG. 1 schematically illustrates an apparatus for the nanostructuring of surfaces 1. An article 3, the surface 4 of which is intended to be nanostructured, is arranged in a mount 2. The article 3 is an article which consists of an amorphous material or at least comprises amorphous material. Materials suitable for structuring include, for example, Zerodur or glasses, for example ULE glass (ultralow expansion glass), that is to say glass having a very low coefficient of thermal expansion. ULE glass has a zero crossing for the coefficient of thermal expansion at 20° C.

In order to be able to produce the surface 4 having a low roughness over a large lateral extent in the range of a plurality of millimeters or even a plurality of centimeters or decimeters, the surface 4 is firstly treated by means of a mechanical polishing method. As a result, the surface 4 of the article 3 acquires a roughness which is locally of the order of magnitude of 1 nm or slightly less than that. Over the entire lateral extent, after such mechanical polishing, the surface 4 still has height differences of up to 100 nm, generally of the order to magnitude of 30 nm to 70 nm. If a coordinate system 5 is associated with the surface 4, then the surface 4 lies in a plane parallel to a plane spanned by an X-axis 6 and a Y-axis 7 of the coordinate system 5. The height of the surface 4 is measured along the Z-axis 8. The mechanical polishing of the surface 4 can be performed before the article 3 is inserted into the mount 2.

The mount 2 is coupled to actuators 9, 10, which can move the mount in the X and Y directions, such that the article 2 or the surface 4 can thereby be moved in the xy plane or parallel to the xy plane.

In order to determine the height differences over the lateral extent of the surface 4 of the article 3, an interferometer 11 is used. In this case, a scanning beam 12 is moved over the surface 4 of the article 3, such that the scanning beam 12 of the interferometer 11 scans the surface 4. The relative movement between the scanning beam 12 and the article 3 is preferably performed by means of the actuators 9, 10, which move the mount and thereby also move the article 3 in the xy plane. By this means, the heights of the surface 4 can be determined locally over the entire surface 4 and a height map 13 can thus be produced. This reveals the height fluctuations on the surface 4 of the article 3.

In order to structure the surface 4 in the nanometer range, short-pulse laser radiation 15 generated in a short-pulse laser 16 is applied to said surface. Conventional commercially available lasers, for example Ti: sapphire lasers, with an amplifier are appropriate as the short-pulse laser 16. The short-pulse laser radiation 15 emerging from the laser 16 is guided onto the surface 4 of the article 3 by means of a beam guiding device 17. The beam guiding device 17 comprises, for example, a planoconvex lens 18 and—coupled thereto—a diffractive optical element 19 (DOE) as beam shaping device 20, which shapes a beam profile of the short-pulse laser radiation 15 in the region of the surface 4 of the article 3. The beam profile is preferably influenced in such a way that it is homogeneous over an entire cross-sectional area A_{short-pulse beam}. By way of example, so-called cylindrical beam profiles (top-hat profiles) or else rectangular profiles are appropriate. Instead of a diffractive optical element, it is also possible to use refractive beam shaping elements. Alongside the beam shaping device 20, the beam guiding device 17 comprises, if appropriate, further optical elements 21, such as, for example, mirrors, gratings or the like. Some of these can also be able to be drivable by means of a controller 25.

The short-pulse laser 16 preferably generates laser radiation in the infrared wavelength range, for example at 800 nm. The short-pulse laser can thus be embodied as a Ti: sapphire laser, for example. The individual laser pulses preferably have a pulse duration in the femtosecond range, particularly preferably in the range of between 100 fs and 300 fs. The article 3 has to be transparent in the wavelength range of the short-pulse laser radiation 15 used.

By means of the beam shaping device 19 and also the short-pulse laser 16, a fluence F is chosen such that, for each individual pulse, the said fluence is below a multishot threshold fluence Fₜₕ. Particularly preferably, the fluence F is chosen to be in the range of 65% to 95% of the multishot threshold fluence Fₜₕ. Said multishot threshold fluence Fₜₕ indicates the fluence F starting from which ablation of the material occurs upon multishot application. The fluence F is furthermore chosen such that no Coulomb explosion occurs.

As a result of this choice of the fluence F, preferably in the range of between 65% and 95% of the multishot threshold fluence Fₜₕ, but at all events less than the multishot threshold fluence Fₜₕ, yet nevertheless high enough that nonlinear interactions can be initiated, what is achieved is that defects can be produced in the article 3 by means of nonlinear processes. Said defects have the effect that the article 3 is compressed and a height of the surface 4 is altered, i.e. reduced, as a result. This reduction is designated as the structuring depth d. In attenuated form, a compression likewise takes place on a rear side 26 of the article 3. In the case of structuring of a 2 mm thick Zerodur plate, an effect attenuated by the factor 10 was observed on the rear side 26. In order to achieve a uniform roughness of the surface 4, those regions 27 which, in accordance with the height map 13, have a greater height than the lowest regions are nanostructured by means of the short-pulse laser radiation 15. For this purpose, the mount 2 and, by means of the latter, the article 3 and also the surface 4 are moved by means of the actuators 9, 10 parallel to the xy plane. The actuators 9, 10 therefore form a scanning device 30. Preferably, the surface 4 is scanned along parallel lines 31, this being effected overall at least locally preferably in a meandering fashion. This is illustrated schematically in FIG. 2. The individual overlapping impingement regions 32 of the laser pulses are illustrated in circular fashion. The impingement regions 32 mirror a beam cross section of the short-pulse laser radiation 15.

The structuring depth d is dependent on an effective pulse number N, which, in the case of linear scanning of the surface, is given by the following formula:

$$N = \frac{R}{Δ z \cdot v} \cdot {A}_{short \text{-} pulse beam} ,$$

wherein R indicates the repetition rate of the individual pulses, Δz indicates a distance between the adjacent lines 31, and v indicates a velocity of the relative movement of the short-pulse laser radiation 15 with respect to the surface 4 of the article 3 in the xy plane, i.e. a velocity being along the lines 31, and A_{short-pulse beam} indicates an area of the short-pulse laser radiation on the surface. A region in which the intensity is greater than 1/e² of the maximum intensity of the short-pulse laser radiation is considered as the area. The formula indicated makes it possible, in a targeted and controlled manner, by means of a suitable choice of the effective pulse number of pulses that locally strike a position of the surface 4, to control the structuring depth thereof in the subnanometer range. The structuring depth d can be calculated in accordance with the following formula:

d=k*N^{c}

wherein N is the effective pulse number, k is a proportional constant dependent on the material of the article 3, and c is a constant having a value in the range of between 0.45 and 0.55.

FIGS. 3a and 3b in each case schematically illustrate a contour map 13 of a surface 4 of an article 3 which is in each case structured locally by means of short-pulse laser radiation. These contour maps 13 are recorded after structuring. FIG. 3a shows structuring of Zerodur at the wavelength λ=800 nm, with a line distance of Δz=5 μm and a velocity v=4 mm/s with a relative fluence F/Fₜₕ=0.85. Overall, the structuring is performed with a structuring depth d of 52 nm. An rms roughness (root mean square deviation) is 0.6 nm in the structured target region 41. FIG. 3b shows corresponding structuring by 45 nm for ULE glass, wherein a wavelength of 800 nm, a velocity v=0.05 mm/s and a line distance of Δz =70 μm and a relative fluence F/Fₜₕ=0.9 are used. The rms roughness (root mean square deviation) achieved is 0.8 nm in this case.

As can be seen from FIGS. 4a and 4b, the structuring depth can be set precisely by means of the number of effective pulses N. In said figures, the structuring depth d is plotted against the effective pulse number N. Values for Zerodur are indicated in FIG. 4a, and values for ULE glass in FIG. 4b. Said figures in each case show measured values for short-pulse laser radiation in the infrared wavelength range at λ=800 nm, empty circles and triangles, respectively, and in the visible wavelength range at a wavelength of λ=400 nm (blue light), full circles and full triangles, respectively. It can be discerned very well that in the infrared wavelength range, surprisingly, a very much greater structuring depth and also a specific structuring depth with very much lower pulse numbers are possible. By using ultrashort-pulse laser radiation in the infrared wavelength range, it is thus possible to perform structuring very much better, that is to say that structuring of larger height differences is possible. Secondly, the number of materials which can be structured is extended, since materials which are transparent in the infrared wavelength range can be structured. It is still a prerequisite, of course, that the materials are amorphous or at least comprise an amorphous component.

FIG. 5 illustrates the structuring depth relative to an individual pulse duration in each case for three different effective pulse numbers. Firstly, it can again be discerned that the pulse number influences the modification depth. A very much lower dependence on the individual pulse duration can be discerned. Overall, however, it emerges that the best structuring results are achieved for pulse durations in the range of pulse durations of 100 to approximately 300 fs.

Investigations have revealed that there is generally a maximum structuring depth dₘₐₓ for the individual materials. This means that the structuring depth d indicates transition to saturation with very large pulse numbers N. The structuring depth d can also be specified depending on the maximum structuring depth dₘₐₓ by means of the following empirical formula:

d=dₘₐₓ(1−e^{-b·N}^{^{c}})

In this case, dₘₐₓ indicates the maximum achievable structuring depth, b is a parameter, N is the effective pulse number defined above, and c is the exponent already indicated above, which can assume values in the range of between 0.45 and 0.55.

This relationship is illustrated schematically in FIG. 6, where the structuring depth is plotted against the effective pulse number.

It is thus evident that the structuring depth can be set in a targeted manner by a suitable choice of a line distance, a relative movement along the lines and also a fluence and a pulse duration. In the embodiment described above, the relative movement is achieved by means of a displacement of the article 3 parallel to the xy plane. Other embodiments can provide for the short-pulse laser radiation 15 to be moved relative to a stationary article 3. Yet other embodiments can provide a combination, wherein both the article and short-pulse laser radiation are moved relative to a stationary coordinate system.

One particular advantage in the use of the method described and of the apparatus described is that the article having the surface 4 to be structured does not have to be introduced into a vacuum for the purpose of structuring. Both the structuring and the measurement of the height differences can be performed under normal atmospheric conditions. The latter can, on the one hand, be carried out beforehand, and subsequently for control purposes, but can also be performed during the structuring at the same location or a location situated adjacent to the structuring.

As is evident from the formula for calculating the effective pulse number, in some embodiments the structuring depth can also be performed by means of a variation of the repetition rate.

The controller 25 is preferably designed in such a way that it controls the short-pulse laser 16, the beam guiding device 17 and/or the scanning device 30 and also preferably the interferometer 11. The actuators 9, 10 are driven via the scanning device 30 or directly. The driving of the beam guiding deice 17 comprises the driving of all components which influence a beam profile and/or a guidance of the short-pulse laser radiation. The control of the short-pulse laser 16 is also considered to include the driving of amplifier components, etc.

For the person skilled in the art it goes without saying that only exemplary embodiments of the invention have been described.

List of Reference Symbols
1 Apparatus for nanostructuring
2 Mount
3 Article
4 Surface
5 Coordinate system
6 x-axis
7 y-axis
8 z-axis
9 Actuator
10 Actuator
11 Interferometer
12 Scanning beam
13 Height map
15 Short-pulse laser radiation
16 Short-pulse laser
17 Beam guiding device
18 Planoconvex mirror
19 Diffractive optical element
20 Beam shaping device
21 Further elements
25 Controller
30 Scanning device
26 Rear side
27 Regions
31 Lines
32 Impingement regions
41 Target region

1-14. (canceled)

15. A method of producing nanostructured surfaces, the method comprising the following steps:
providing an article having a surface to be structured;
generating short-pulse laser radiation with laser pulses having pulse durations in a sub-nanosecond range;
directing the short-pulse laser radiation onto the surface of the article to be structured,
and thereby controlling the short-pulse laser radiation such that a fluence F of each individual pulse of the short-pulse laser radiation on the surface is less than a multishot threshold fluence Fₜₕ for a multishot laser ablation and the short-pulse laser radiation, by way of nonlinear effects, producing defects in the article that lead to a local compression of the article and a structuring of the surface.

16. The method according to claim 15, wherein the laser pulses have a pulse duration shorter than 10 ps.

17. The method according to claim 15, which comprises choosing a fluence F in a range of 50% to 99% of the multishot threshold fluence Fₜₕ.

18. The method according to claim 15, which comprises choosing a fluence F in a range of 65% to 95% of the multishot threshold fluence Fₜₕ.

19. The method according to claim 15, which comprises choosing the fluence F to lie below a threshold starting from which a Coulomb explosion can occur.

20. The method according to claim 15, which comprises generating the short-pulse laser radiation with a wavelength in an infrared wavelength range.

21. The method according to claim 15, which comprises moving the article and the short-pulse laser radiation relative to one another, to thereby cause an impingement point of the short-pulse laser radiation to scan a region to be structured on the surface.

22. The method according to claim 21, which comprises scanning the region in meandering fashion along parallel lines.

23. The method according to claim 22, which comprises controlling a structuring depth d in dependence on an effective pulse number N, wherein the effective pulse number is given by:
$$N = \frac{R}{Δ z \cdot v} \cdot {A}_{short \text{-} pulsebeam} ,$$
where R is a repetition rate of the individual pulses, Δz indicates a distance between mutually adjacent lines, v indicates a velocity of a relative movement of the short-pulse laser radiation along the lines (31), and A_{short-pulse beam} indicates an area of the short-pulse laser radiation in a waist.

24. The method according to claim 15, which comprises controlling a structuring depth d in accordance with the following formula:
d=k·N^{c},
where N is the effective pulse member, k is a proportionality constant dependent on a material of the article, and c is a constant having a value in a range between 0.45 and 0.55.

25. The method according to claim 15, which comprises generating the short-pulse laser radiation with a beam profile that is virtually homogeneous over a beam cross section, or shaping the beam profile correspondingly.

26. The method according to claim 15, which comprises introducing into the process an interferometric measurement of the surface to be structured on the article in order to detect and/or indicate height fluctuations on the surface.

27. The method according to claim 26, which comprises controlling a structuring depth d in a manner adapted to the height fluctuation in order to produce a large-area roughness of the surface of an order of magnitude of a local roughness prior to structuring.

28. An apparatus for producing a nanostructure surface on an article, comprising:
a short-pulse laser for generating short-pulse laser radiation with laser pulses having pulse durations in a sub-nanosecond range;
a mount for receiving the article having the surface to be structured;
a beam guiding device for guiding the short-pulse laser radiation onto the surface to be structure;
said short-pulse laser and said beam guiding device being configured such that a fluence F of each individual pulse of the short-pulse laser radiation (15) on the surface is less than a multishot threshold fluence Fₜₕ for a multishot laser ablation, but is high enough to produce defects in the article by way of nonlinear effects, the defects leading to a compression of the article and the structuring of the surface.

29. The apparatus according to claim 28, wherein the pulse durations of the laser pulses have an extent shorter than 10 ps.

30. The apparatus according to claim 28, which further comprises a scanning device coupled to at least one of said beam guiding device or said mount, said scanning device varying an impingement location of the short-pulse laser radiation on the surface of the article in a controlled manner, to thereby scan the surface with the short-pulse laser radiation in a controlled manner.

31. The apparatus according to claim 28, wherein said short-pulse laser and the beam guiding device are configured to set the fluence F to less than a threshold starting from which a Coulomb explosion can occur.
